(19) United States
(12) Patent Application Publication
(10) Pub. No.: US 2004/0213655 A1
(43) Pub. Date: Oct. 28, 2004

(54) Powered trailer hitch attachment

(76) Inventors: Edwin Lamar Buckner, Flintstone, GA (US); Lynn A. Buckner, Chickamauga, GA (US)

Correspondence Address: LYNN A. BUCKNER, PO Box 609, Chickamauga, GA, 30707, US

(21) Appl. No.: 10/830,932

(22) Filed: Apr. 26, 2004

Related U.S. Application Data
(60) Provisional application No. 60/465,455, filed on Apr. 28, 2003.

(51) Int. Cl. B60P 9/00

(52) U.S. Cl. 414/462

(57) ABSTRACT

A towing vehicle 10 having a female plug in trailer hitch receiver 1 and an electrical connector plug 4, is equipped to use this patent design which comprises a male plug in trailer hitch 2 having a powered means attached, which may consist of a linear actuator 8A and 8B or a hydraulic pump, reservoir and controls 11 or an air compressor 13 with a compressed air storage tank 14. The powered means 8A, 11 or 13 may be powered by plugging it into the 12-volt electrical system of the towing vehicle by means of connector 4 and 5 and power cord 6. Thus a compact easy to attach power means may be coupled to the vehicle plug in trailer hitched and plugged into a trailer electrical plug in order to have a powered platform means to load, transport and unload items such as a boat, canoe, kayak, skis, ultra light air plane, camping gear rack, and luggage rack.

### FIELD OF THE INVENTION

The present invention relates generally to a means of transporting recreational and service items above or on top of a vehicle and having a powered means to move said items from the ground to the top of a vehicle and then unload again. More specifically, the invention is a compact, easy to attach power means in order to have a power means to raise, lower or move items from the ground to a trunk, above the vehicle or truck bed elevation.

### DESCRIPTION OF RELATED ART

The related art of interest describes various lifting means attachable to vehicles, but none discloses the present invention.

U.S. Pat. No. 4,746,263, issued on May 24, 1988 to Larry D. Cook, describes a vehicle bumper stored telescopic crane hoist comprising a mast telescopically receiving a boom which supports a power head or winch assembly. The mast is supported by a jack.

However the problem with the prior art is that it does not provide a storage and transport means, as well as with the limited load structure which may be lifted and the limited arrangement of where the load may be lifted to. With the prior art device, larger items, such as a boat, would require more than one operator, cause unneeded lifting which may result in back strain, and may more easily cause scratches on the vehicle.

The primary objective of the present invention is to provide a compact, easy to attach power means to load and carry and unload, having a means to raise, lower or move items such as a boat, canoe, kayak, skis, ultra light air plane, camping gear rack, luggage rack, platform and various other structures.

### SUMMARY OF THE INVENTION

The above described objectives and others are met by a male portion of a plug in trailer hitch having a powered means attached, which may consist of a linear actuator and or a hydraulic pump, reservoir and controls or an air compressor with a compressed air storage tank. The powered means may be powered by plugging it into the 12-volt electrical system of the towing vehicle by means of connector and power cord. The powered means may be connected to a bracket, which may be connected to any of an item to be lifted, a support rack and a parallel support system.

### BRIEF DESCRIPTION OF THE DRAWINGS

While the specification concludes with claims particularly pointing out and distinctly claiming the subject matter which may be regarded as forming the present invention, it is believed that the invention will be better understood from the following description taken in conjunction with the accompanying drawings, in which:

FIG. 1 is a towing vehicle 10 with a mounting bracket 7 attached to support a linear actuator motor 8A and telescoping linear actuator cylinder 8b, according to a preferred embodiment of the invention.

FIG. 2 is a hydraulic power unit 11 and hydraulic cylinder 12 mounted on a mounting bracket 7, according to an embodiment of the invention.

FIG. 3 is an air compressor with controls 13 and air storage reservoir 14 and an air cylinder 15 mounted on a mounting bracket 7, according to an embodiment of the invention.

FIG. 4 illustrates a stabilizer means to secure the male plug in trailer hitch 2 to the female plug in trailer hitch 1, according to an embodiment of the invention.

FIG. 5 is the device of FIG. 1 with the addition of a support rack 20, 22 and 23, according to an embodiment of the invention.

FIG. 6 is the device of FIG. 2 with the addition of a support rack 20, 22 and 23, according to an embodiment of the invention.

FIG. 7 illustrates dual power systems 8A and 8B with two storage racks 22, according to an embodiment of the invention.

FIG. 8 illustrates a parallel support system used to support the storage rack 22, according to an embodiment of the invention.

FIG. 9 illustrates dual parallel support systems, according to an embodiment of the invention.

FIGS. 10A-10C illustrates the positional relation between the storage rack 22 and the towing vehicle 10 as the storage rack 22 is raised and lowered, according to an embodiment of the invention.

FIG. 11 illustrates a side elevation of a boat 31 loaded, raised and stored on a rack over a vehicle, according to an embodiment of the invention.

FIG. 12 illustrates a side elevation showing how a boat 31 may be raised, stored and secured onto a vehicle, according to an embodiment of the invention.

### DETAILED DESCRIPTION OF THE INVENTION

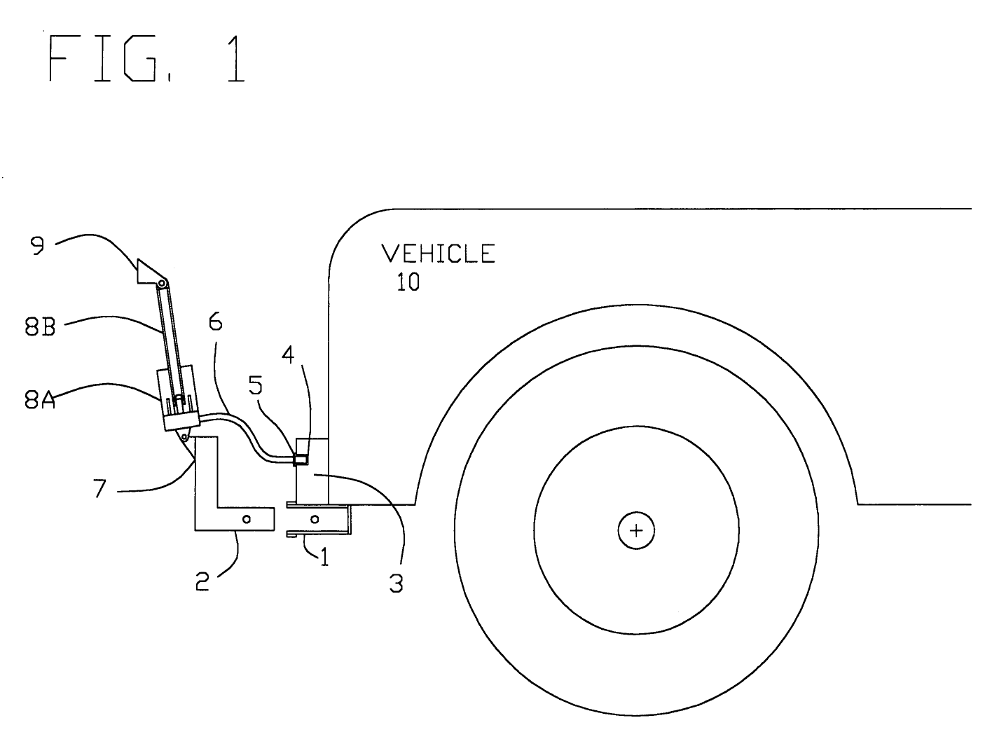

FIG. 1 illustrates a towing vehicle 10 with a trailer hitch receiver 1 and an electrical wiring plug in 5 attached. A trailer hitch male plug in 2 has a mounting bracket 7 attached to support a power source. Which in this example is a linear actuator motor 8A and telescoping linear actuator cylinder 8B having a bracket 9 attached to any item desired to be moved by the power source 8A and 8B. A power cord 6 is attached to the actuator motor 8A at a first end and to an electrical plug in 5 at a second end. The electrical plug 5 mates with the plug in 4 receiver power source of vehicle 10.

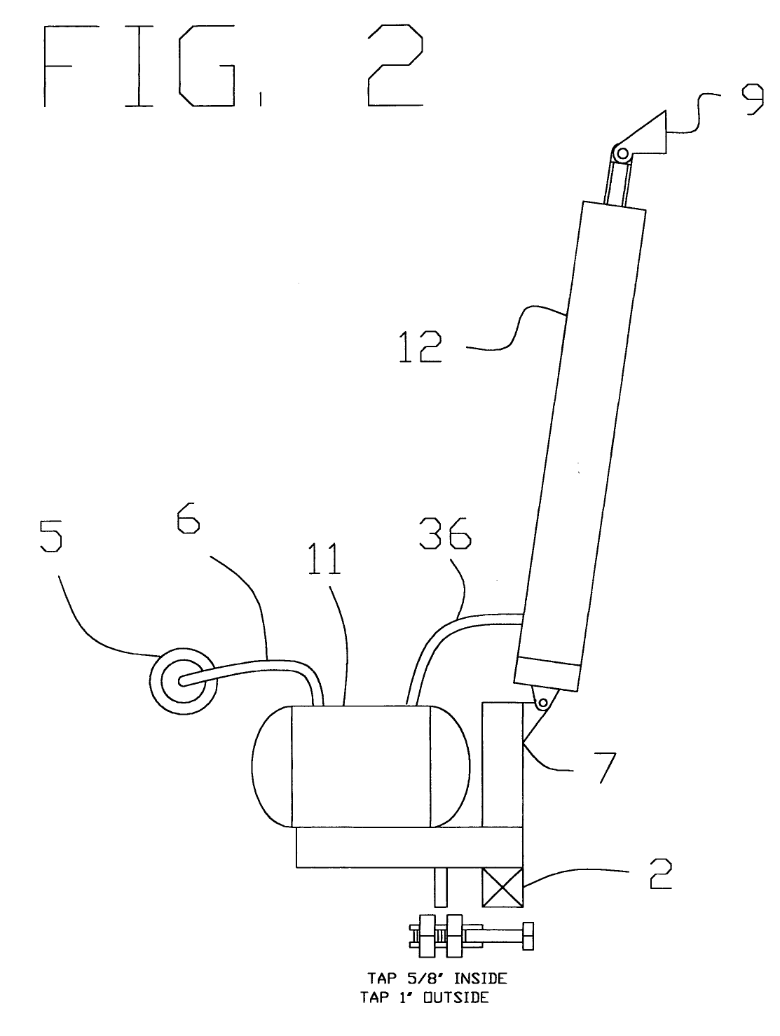

FIG. 2 is similar to FIG. 1 except that in FIG. 2 the power source is illustrated as a hydraulic power unit 11 consisting of a motor, pump, reservoir, and controls. Power cord 6 transfers power from plug in power source 5 to the hydraulic power unit 11. Hydraulic power is transferred through hydraulic hoses 36 to hydraulic cylinder 12, which telescopes in or out to move the item chosen to be attached to bracket 9.

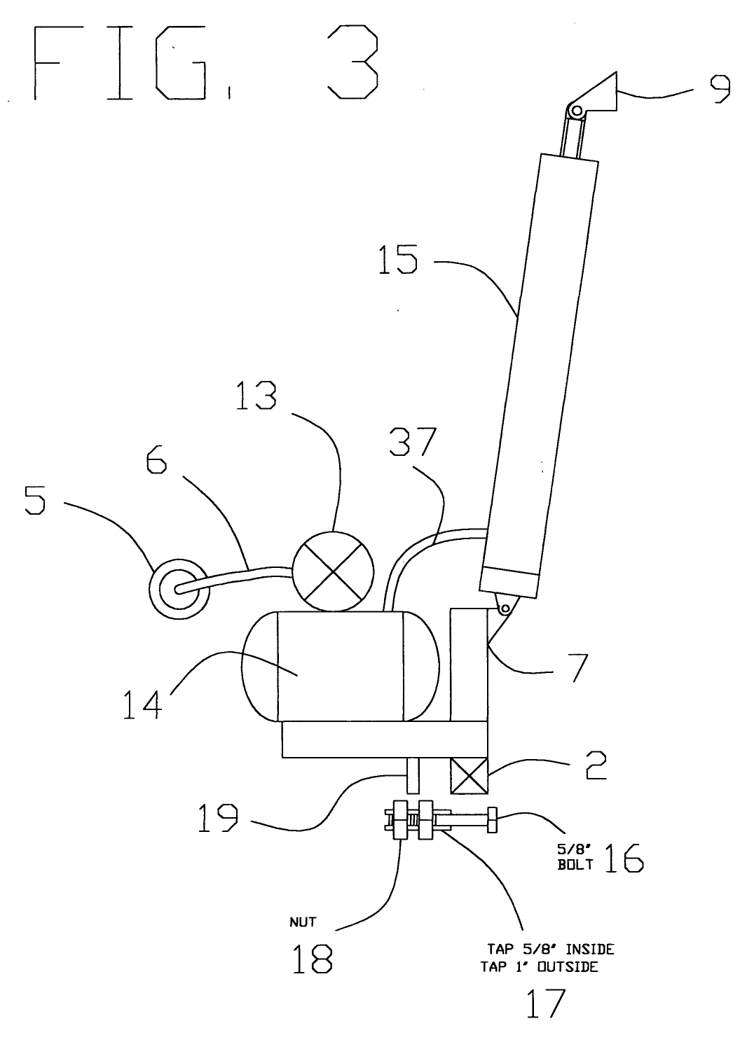

FIG. 3 is similar to FIG. 1 or 2 except that in this example the power source is an air compressor with controls 13 with an air storage reservoir 14. Again the vehicles electrical power supply furnishes electricity through plug in 5 through power cord 6 to the air compressor 13. Air lines 36 convey compressed air to air cylinder 15, which is caused to telescope longer or shorter in order to move any item attached to bracket 9.

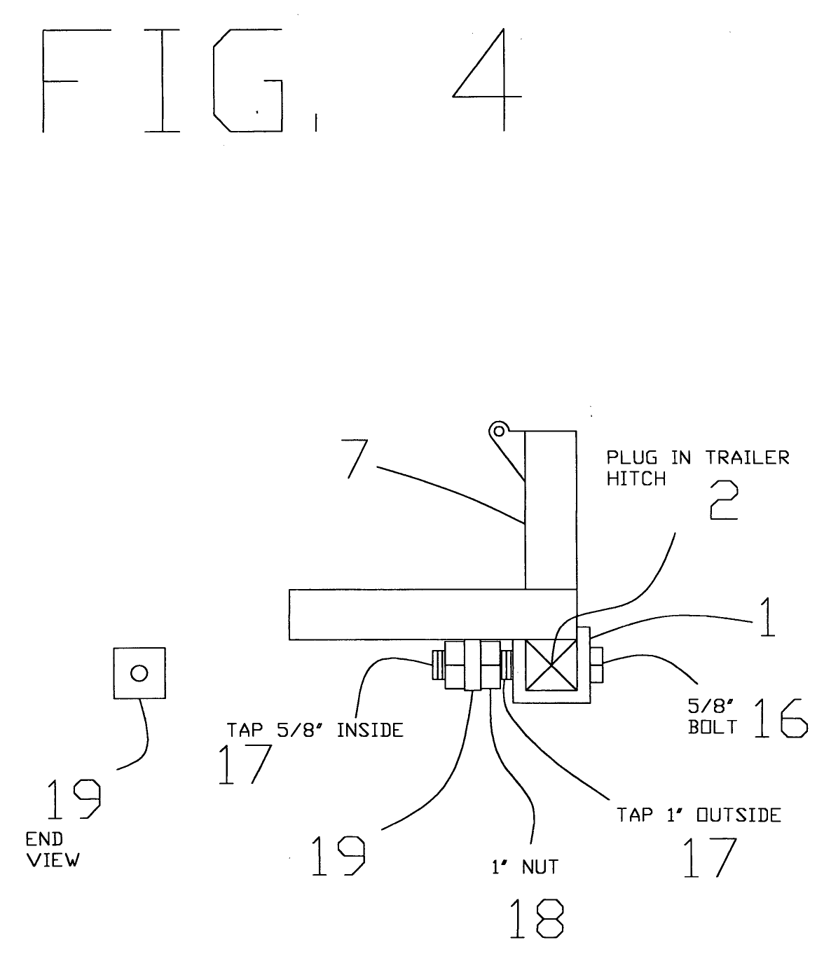

FIG. 4 illustrates a stabilizer means to secure the male plug in trailer hitch 2 to the female plug in trailer hitch 1, which is attached to vehicle 10. Bolt 16 is bolted through hitch part 1 and 2 to keep them from uncoupling. Bolt 16 is long enough to also bolt securely through mounting plate 19, which is a part of bracket 7. A combination of dual inside and outside taped nut 17 and nuts 18 secure bracket 7 to the vehicle receiver hitch 1, thus minimizing side movement.

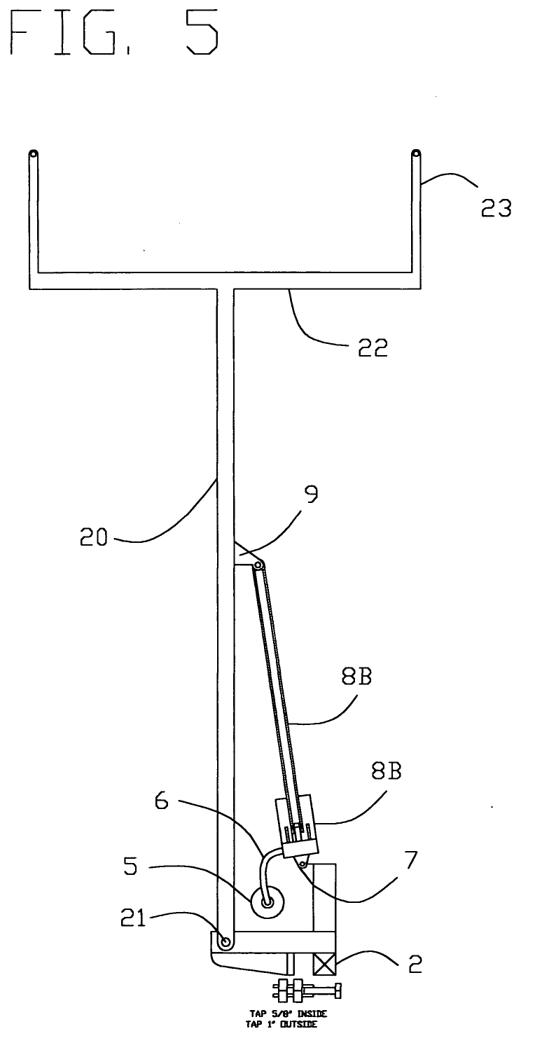

FIG. 5 is similar to FIG. 1 except that the addition of a support rack consisting of 20, 22 and 23 has been attached. The primary support arm 20 is attached to bracket 9 and also pivot connector 21 allows support arm 20 to rotate in relation to bracket 7. A storage rack 22 with side support 23 is attached at the top of primary support arm 20.

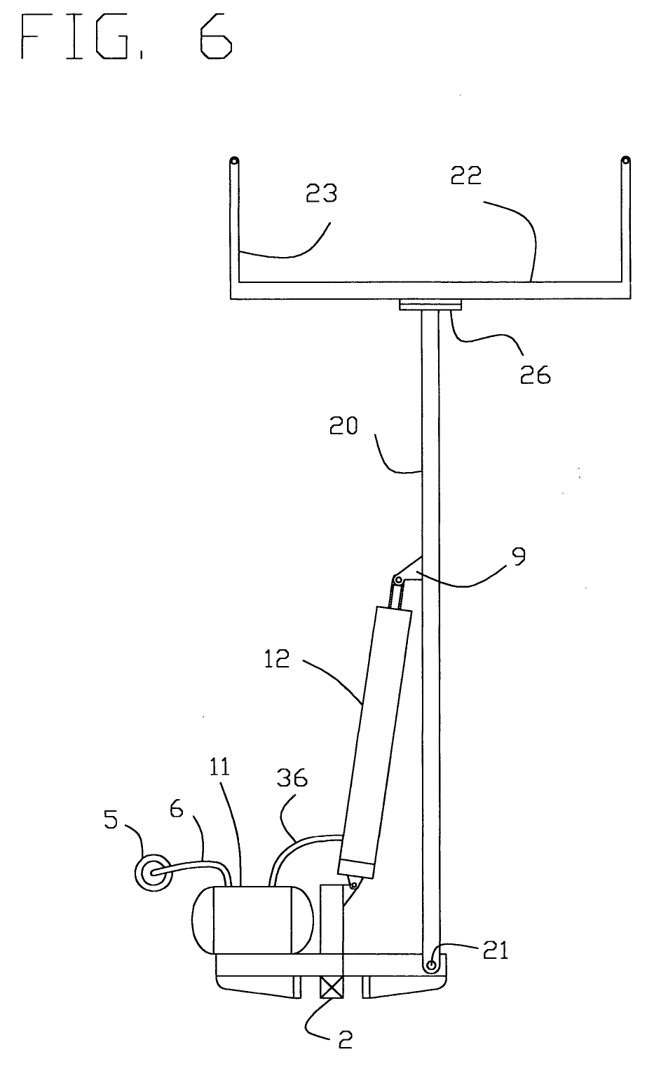

FIG. 6 is similar to FIG. 5 except that in this illustration a hydraulic power unit 11 is used to move the primary support arm 20 with attached storage rack 22. A rotating joint with latching means 26 is located between support arm 20 and storage rack 22 so that the storage rack 22 may be rotated as needed.

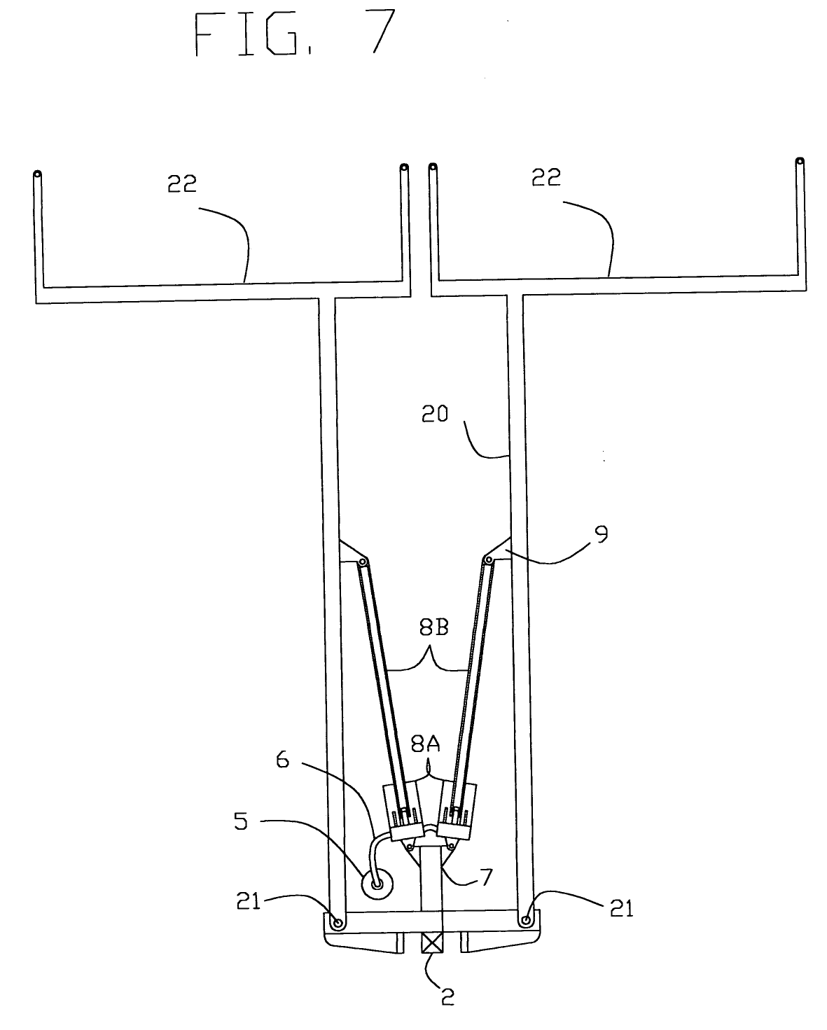

FIG. 7 is similar to FIG. 5 except that a double power system 8A and 8B with two storage racks 22 are attached to a single plug in trailer hitch 2.

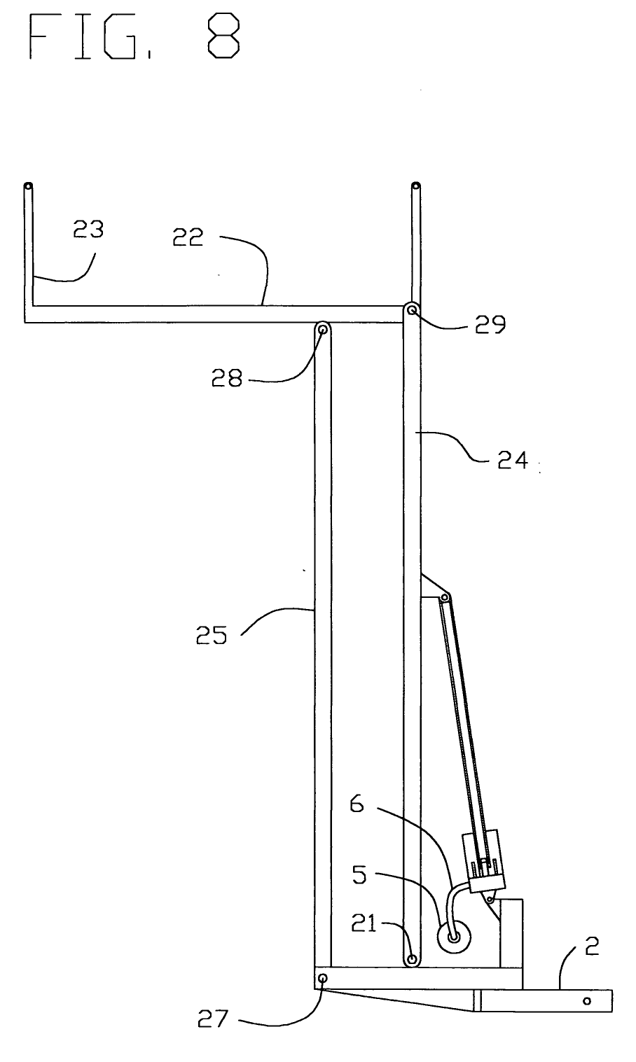

FIG. 8 is similar to FIG. 5 except that a parallel support system is used to support the storage rack so that as the linear actuator 8A extends to lower the storage rack 22, it remains level. Primary support arm 24 is attached to bracket 9 and has a pivot connector 21 to connect it to bracket 7 and pivot connector 29 to connect it to storage rack 22. A parallel arm 25 has a pivot connector 27 to attach it to bracket 7 and pivot connector 28 to attach it to the storage rack maintains a horizontal relation to the vehicle.

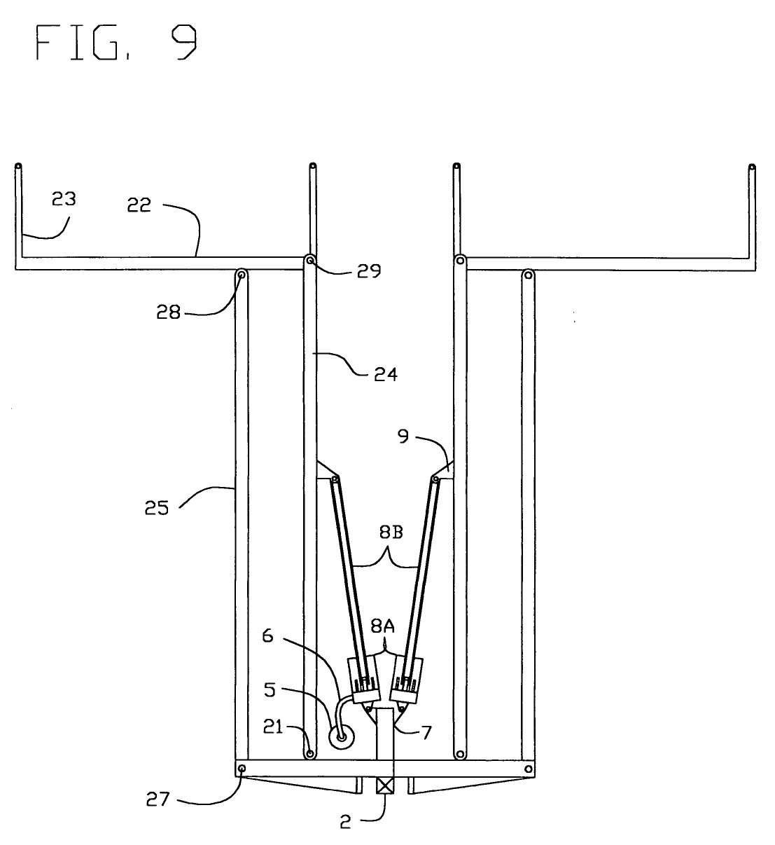

FIG. 9 is similar to FIG. 8 except that two moveable storage racks are mounted on a single plug in trailer hitch 2.

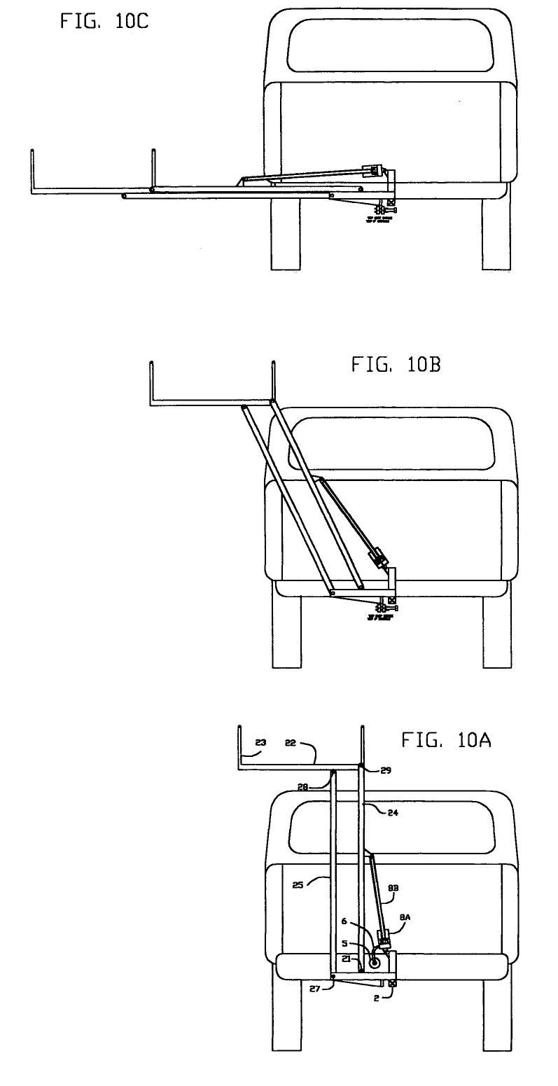

FIG. 10 is similar to FIG. 8 except that it illustrates the horizontal relation between the storage rack 22 and the towing vehicle 10 as the storage rack 22 is raised or lowered. FIG. 10A illustrates the rack in the full up position. FIG. 10B illustrates the storage rack partially lowered. FIG. 10C illustrates the rack in a down position.

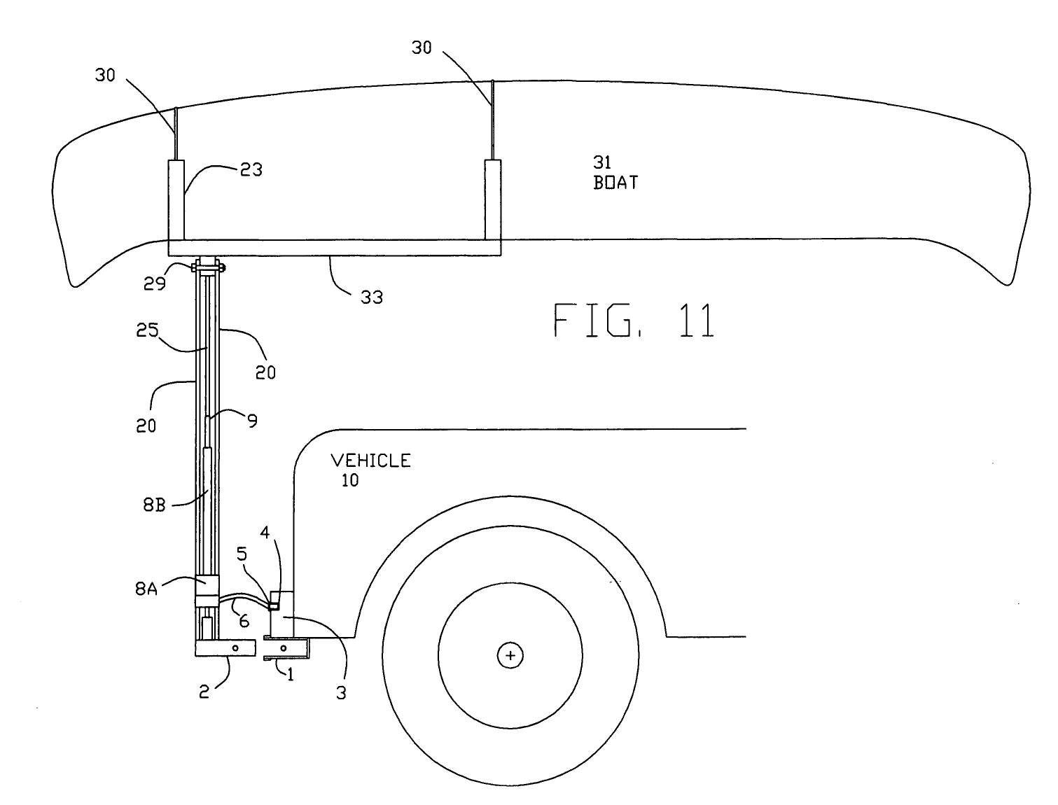

FIG. 11 is similar to FIG. 8 except that it is a side elevation and shows a boat 31 as an example of items, which may be loaded, raised, stored or hauled on a rack over a vehicle. Rack extension 33 illustrates how a longer item may be supported by the rack 22. Straps 30 secure the canoe to the rack.

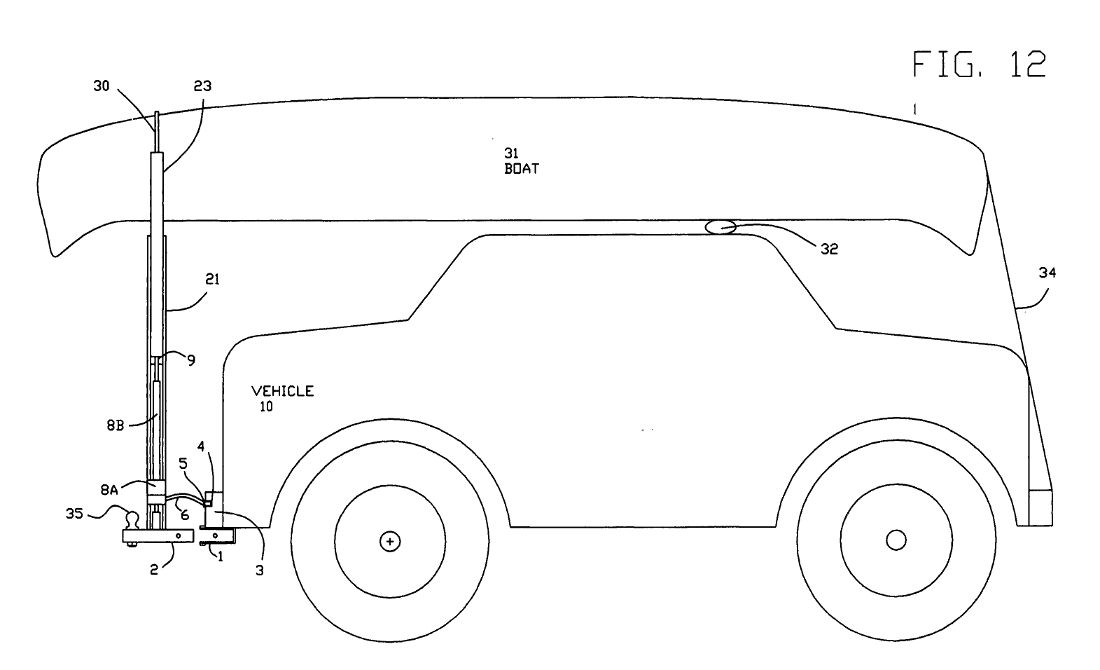

FIG. 12 is similar to FIG. 8 or FIG. 5 except that it is a side elevation showing how a kayak 31 may be raised, stored, and secured onto a vehicle. In this illustration, the powered lift raises one end of the canoe 31 and a person raises the other end of the canoe 31. A remote control may be used to activate the power source by the operator.

While particular embodiments of the invention have been shown, it will be understood, of course, that the invention is not limited thereto since modifications may be made by those skilled in the art, particularly in light of the foregoing teachings. Reasonable variation and modification are possible within the scope of the foregoing disclosure of the invention without departing from the spirit of the invention.

# Definition

1—Towing vehicles plug in trailer hitch receiver (female)

2—Plug in trailer hitch (male)

3—Bumper of towing vehicle

4—Towing vehicle's plug in electric connection, generally for trailer lights and electrical power source

5—Electric connector to plug into towing vehicle's electric connection

6—Electric power cord

7—Trailer hitch support frame to mount power unit to

8A—Linear Actuator power head

8B—Linear Actuator telescoping cylinder means

9—Telescoping cylinder mounting bracket

10—Towing vehicle

11—Hydraulic powered unit which may include hydraulic pump, motor, hydraulic reservoir and controls

12—Hydraulic cylinder

13—Air compressor

14—Compressed air storage tank

15—- - -

16—Bolt to secure the two parts of the receiver hitch (Example—nominal 2″ plug in receiver hitches generally use a ⅝″ bolt)

17—Fastener having both inside threads to receive bolt 16 and also having outside threads to screw jam nuts 18 onto. Fasteners length is sufficient to secure male portion of the trailer hitch to the female portion of the trailer hitch and reduce movement between the two.

18—Jam nut to screw onto fastener 17 and to secure stability of mount steady support 19

19—Mount steady support for trailer hitch part 2

20—Single primary support arm to mount storage rack 22 to and to attach telescoping cylinder mount 9 to and which has a pivot connector 21

21—Pivot connector for the primary support arm 20 or 24 to connect them to the trailer hitch 2

22—Storage rack

23—Side supports for storage rack

24—Primary support arm having both a pivot connector 21 and a pivot connector 29

25—Secondary parallel support arm having a pivot connector 27 and a pivot connector 28. This secondary support arm is mounted parallel to the primary support arm 24 they move simultaneously and parallel to each other and thus move storage rack 22 while maintaining storage rack 22 on a given plane.

26—Rotating connector mounted to the base of storage rack 22 so as to allow storage rack 22 to be rotated

27—Pivot connector to attach secondary parallel support arm 25 to the trailer hitch 2

28—Pivot connector to attach secondary parallel support arm 25 to the storage rack 22

29—Pivot connector to attach the primary support arm 24 to the storage rack 22

30—Banding strap to secure stored item such as a boat 31 to the storage rack 22

31—Boat or canoe

32—Cushion support which may be placed between a boat 31 and the top of a vehicle 10

33—Extension to the storage rack 22

34—Rope to secure the front of a boat to the front of a vehicle 10

35—Trailer hitch ball

36—Hydraulic hoses

37—Air line hoses

What is claimed:

1. A plug in vehicle trailer hitch loading, carrying, and unloading method, comprising a female receiver hitch attached to a vehicle, a male plug in hitch support bracket having an articulating support arm, a storage platform supported by said articulating support arm to store and carry items loaded on it, and a powered means to articulate the support arm and attached platform with cargo.

2. A method of claim 1, wherein said powered means is one of a linear actuator, a hydraulic cylinder with a motor, pump, reservoir and controls, and an air cylinder with controls to supply lifting power.

3. A method of claim 1, wherein a stabilizer means is used to secure said male hitch plug to said vehicle female receiver hitch, a bolt is bolted through said male and female parts of the trailer hitch to avoid uncoupling, said bolt being long enough to bolt securely though an additional support bracket and a combination of dual inside and outside taped nuts secure said support bracket to said receiver hitch in order to minimize side movement of said male plug in portion of said hitch in relation to said female receiver hitch.

4. A method of claim 1, wherein a support rack comprising a primary support arm attached to said bracket, a pivot connector allows said support arm to rotate in relation to said bracket, and a storage rack with a pair of side supports attached at the top of said primary support arm.

5. A method of claim 1, wherein a double power system and a double storage rack system are attached to a single plug in trailer hitch.

6. A method of claim 1, wherein said articulating support arms are parallel used to support a storage rack in order that said storage rack remains level while lowering, loading, raising and carrying in the stored position.

7. A method of claim 1, wherein a remote control is used to operate said power means.

8. The method of claim 1, 2, 3, 4, 5, 6 and 7, wherein said loading, unloading and storing platform is lowered to the proximity of ground level for easy loading of luggage, bicycles, canoes, kayak, skiing equipment, camping gear, ultra light air craft, tools or ladders and after loading said platform with cargo is moved into a secure elevated position above said vehicle by said powered articulating support arm, powered by a battery which may be recharged by said vehicle's electrical system, and after transporting to a determined location said platform may be again lowered by said powered articulating support arms to within proximity of the ground for easy unloading.
